(19) United States
(12) Patent Application Publication
(10) Pub. No.: US 2013/0132393 A1
(43) Pub. Date: May 23, 2013

(54) METHOD AND SYSTEM FOR DISPLAYING ACTIVITIES OF FRIENDS AND COMPUTER STORAGE MEDIUM THEREFOR

(71) Applicants: Min Chen, Shenzhen City (CN); Qing Zhou, Shenzhen City (CN); Shuyang Lin, Shenzhen City (CN); Xiaojun Huang, Shenzhen City (CN); Yong Yang, Shenzhen City (CN); Zhihao Zheng, Shenzhen City (CN); Zhu Liang, Shenzhen City (CN); Shan Chen, Shenzhen City (CN); Xiao Xu, Shenzhen City (CN)

(72) Inventors: Min Chen, Shenzhen City (CN); Qing Zhou, Shenzhen City (CN); Shuyang Lin, Shenzhen City (CN); Xiaojun Huang, Shenzhen City (CN); Yong Yang, Shenzhen City (CN); Zhihao Zheng, Shenzhen City (CN); Zhu Liang, Shenzhen City (CN); Shan Chen, Shenzhen City (CN); Xiao Xu, Shenzhen City (CN)

(73) Assignee: TENCENT TECHNOLOGY (SHENZHEN) COMPANY LIMITED, Shenzhen City (CN)

(21) Appl. No.: 13/744,077

(22) Filed: Jan. 17, 2013

Related U.S. Application Data
(63) Continuation of application No. PCT/CN2011/079009, filed on Aug. 26, 2011.

(30) Foreign Application Priority Data
Sep. 26, 2010 (CN) 201010292477.3

(51) Int. Cl. G06F 17/30

(52) U.S. Cl. CPC G06F 17/30598
USPC 707/737

(57) ABSTRACT

Method and system for displaying activities of friends. The method includes, generating activity information from the activities of friends according to the friend relationship chain; classifying the activity information according to the preset classification rule to obtain the corresponding classification collection; acquiring the screening condition, extracting activity information that meets the screening condition from the classification collection, and displaying the activity information extracted. According to the method and system, through the classification and screening of activity information, the activities of friends which meet screening conditions entered by a user can be obtained and displayed. Using this method and the system, a large amount of information can be quickly screened and all the friends' effective activities can be provided to the user allowing user to achieve personalized browsing.

### CROSS-REFERENCE TO RELATED APPLICATIONS

This application is a continuation application of International Patent Application No. PCT/CN2011/079009, filed Aug. 26, 2011, entitled “METHOD AND SYSTEM OF DISPLAYING FRIEND STATUS AND COMPUTER STORAGE MEDIUM FOR SAME”, by Min Chen et al., which itself claims the priority to Chinese Patent Application No. 201010292477.3, filed Sep. 26, 2010, entitled “METHOD AND SYSTEM OF DISPLAYING FRIEND STATUS”, by Min Chen et al., the disclosures for which are hereby incorporated herein in their entireties by reference.

### FIELD OF THE INVENTION

The present invention relates generally to internet technology, and more particularly, to a method, system and computer storage medium for displaying activities of friends.

### BACKGROUND OF THE INVENTION

With the continuous development and popularization of social networking, life on the Internet has become an indispensable part of people's lives. More and more people participate in social networking activities, and the amount of social networking information has grown exponentially. At the same time, social networking services, referred to as SNS, is no longer a relationship between single user to single user, but a relationship between a single user to multiple users, even between multiple users to multiple users. Therefore, the SNS network includes lots of specific information, such as networking users, users' activities and their networking relationships.

Facing a large amount of users and information in SNS network, it is a major issue to obtain the required information and content quickly and efficiently for a traditional SNS network. However, SNS network often displays the activity information of user's friends in a scramble way, in which we cannot obtain required friends' activities quickly.

Therefore, a heretofore unaddressed need exists in the art to address the aforementioned deficiencies and inadequacies.

### SUMMARY OF THE INVENTION

In one aspect, the present invention is directed to a method for displaying activities of friends which can screen the activities of friends' information.

In one embodiment, a method for displaying activities of friends comprises:
generating activity information from the activities of friends according to a friend relationship chain;
classifying the activity information according to a preset classification rule to obtain the corresponding classification collection;
acquiring a screening condition;
extracting activity information that meets the screening condition from the classification collection; and
displaying the activity information extracted.

In one embodiment, the classifying of the activity information according to the preset classification rule to obtain the corresponding classification collection comprises:
extracting an attribute associated with the classification rule from the activity information, according to the preset classification rule; and
classifying the activity information according to the attribute to form the classification collection.

In one embodiment, the classification rule comprises at least one of an information attribute, a friend attribute, and a user event attribute.

In one embodiment, the acquiring of the screening condition, extracting activity information that meets the screening condition from the classification collection, and displaying the activity information extracted comprises:
acquiring the screening condition;
obtaining the classification collection corresponding to the screening condition; and
extracting the activity information from the classification collection corresponding to the screening condition, and displaying the activity information extracted.

In one embodiment, the screening condition comprises multiple screening conditions, and after the obtaining of the classification collection corresponding to the screening condition, and the method further comprises:
retrieving intersection from the classification collection corresponding to the screening condition.

In another aspect, the present invention is directed to a system for displaying activities of friends which can screen the activities of friends' information.

In one embodiment, a system for displaying activities of friends at least includes:
an aggregation server configured to generate activity information from the activities of friends according to a friend relationship chain;
an activity information server configured to classify the activity information according to a preset classification rule to obtain the corresponding classification collection; and
a client terminal configured to acquire a screening condition, extracting activity information that meets the screening condition from the classification collection, and displaying the activity information extracted.

In one embodiment, the activity information server comprises:
an extraction module configured to extract an attribute associated with the classification rule from the activity information, according to the preset classification rule; and
a classification module configured to classify the activity information according to the attribute to form the classification collection.

In one embodiment, the classification rule for the extraction module comprises at least one of an information attribute, a friend attribute, and a user event attribute.

In one embodiment, the client terminal comprises:
an identification module configured to acquire the screening condition;
a screening module configured to obtaining the classification collection corresponding to the screening condition; and
a displaying module configured to extract the activity information from the classification collection, and displaying the activity information extracted.

In one embodiment, the screening condition comprises multiple screening conditions. The client terminal further comprises:
a merge module configured to obtain intersection from the screened classification collection.

In a further aspect, the present invention is directed to a non-transitory computer storage medium having computer-executable instructions stored thereupon which, when executed by a computer, cause the computer to execute a method for displaying activities of friends, the method comprises:
generating activity information from the activities of friends according to a friend relationship chain;
classifying the activity information according to the preset classification rule, to obtain the corresponding classification collection; and
acquiring a screening condition, extracting activity information that meets the screening condition from the classification collection, and displaying the activity information extracted.

In one embodiment, the classifying of the activity information according to the preset classification rule to obtain the corresponding classification collection, comprises:
extracting an attribute associated with the classification rule from the activity information, according to the preset classification rule; and
classifying the activity information according to the attribute to form the classification collection.

In one embodiment, the classification rule comprises at least one of an information attribute, a friend attribute, and a user event attribute.

In one embodiment, the acquiring of the screening condition, extracting activity information that meets the screening condition from the classification collection, and displaying the activity information extracted, comprises:
acquiring the screening condition;
obtaining the classification collection corresponding to the screening condition; and
extracting the activity information from the classification collection corresponding to the screening condition, and displaying the activity information extracted.

In one embodiment, the screening condition comprises multiple screening conditions, and after the obtaining of the classification collection corresponding to the screening condition, the method further comprises:
obtaining intersection from the classification collection corresponding to the screening condition.

Through the above-mentioned method and system displaying activities of friends, after classifying and screening the activity information, we can get and further display friends' activities which meet the screening condition inputted by the user. The invention realizes the rapid screening in large amount of information, providing all the friends' effective activities rapidly for the user, meeting users' demand for personalized browsing.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a flowchart of a method for displaying activities of friends according to one embodiment of the invention;

FIG. 2 is a flowchart of method for displaying activities of friends according to one embodiment of the invention;

FIG. 3 is an interface diagram of an embodiment obtaining the screening condition according to one embodiment of the invention;

FIG. 4 is a schematic diagram of a system for displaying activities of friends according to one embodiment the invention;

FIG. 5 is a block diagram of an embodiment of the activity information server according to one embodiment of the invention; and

FIG. 6 is a block diagram of the client terminal according to one embodiment of the invention.

### DETAILED DESCRIPTION OF THE PREFERRED EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

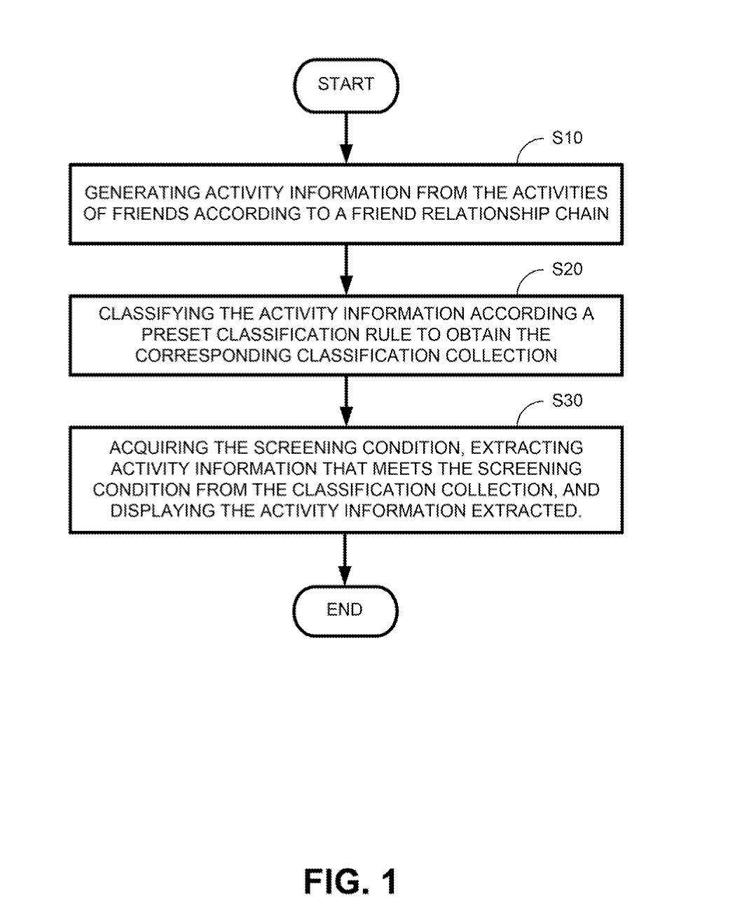

FIG. 1 shows a flowchart of method for displaying activities of friends. The method includes the following steps:
Step S10, generating activity information from the activities of friends according to a friend relationship chain. In this embodiment, the friend relationship chain includes the information of all friends of the user and their contacts. For example, user B, C and D are friends of user A, then B, C and D as well as their information form a simple friend relationship chain of the user A. Friends' activities are the events triggered by user's friends in SNS cyberspace. The activity information is generated from the activities of friends, thus it is easy to view in SNS cyberspace for the user. For example, the activities of friends in user's friend relationship chain can be packaged into a feed-type file. If as the networking friend of user A, user B releases a log in SNS cyberspace. Then, for user A, the activities of friend B is that B released a log. Activity information could be generated to record the activities of friends in a file, of which the format could be feed type.
Step S20, the activity information is classified according to preset classification rules to obtain the corresponding classification collection. In this embodiment, the classification rules comprise one or more of an information attribute, a friend attribute, and a user event attribute. Specifically, every activity owns many different information attributes, which may include information type, time the information is generated and so on. For example, information type can be a log, a photo album, a message, participating in or initiating a vote, etc. Friend attribute can be derived from the friend relationship chain, including age, gender, user group which friends belong to. By researching or observing users' behavior, the attribute of users event can be obtained. The attribute of users event includes the users' activities, the keywords users concerning about and users' demands. For example, from research, we can find out that the user would like to obtain information on a car or travel, and then the current attribute of user event is to obtain information on the car or travel. If user's activity is to search information on education, then the current attribute of user event is to obtain information on education. If the phrase used most frequently by user is environmental protection, then the keyword user concerning about currently is “green”, the current attribute of user event is to obtain information on environmental protection. Obtaining one or more in information attribute, a friend attribute or users' event attribute as the classification rules, a large amount of activity information can be classified by using these classification rules. For example, if the classification rule is based on information attribute, the activity information would be classified by information attribute. As mentioned earlier, information attributes include information type and the time the information is generated, so activity information is classified according to information type and the time the information is generated to obtain classification collection related to information type and the time the information is generated.
Step S30, acquiring the screening condition, extracting activity information that meets the screening condition from the classification collection, and displaying the activity information extracted. In this embodiment, acquiring the screening condition inputted by the user, according to the screening condition, the activity information that meets the screening condition from the classification collection can be extracted and displayed. For example, the screening condition could be logs for the last three days. In addition, the user can also select multiple screening conditions, such as friends' logs and albums during the last three days.

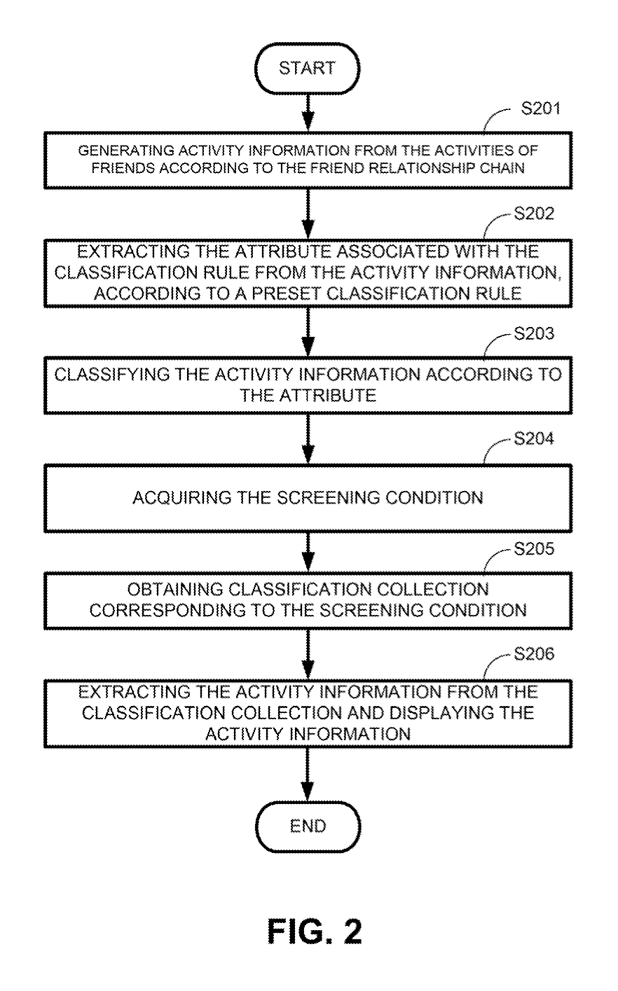

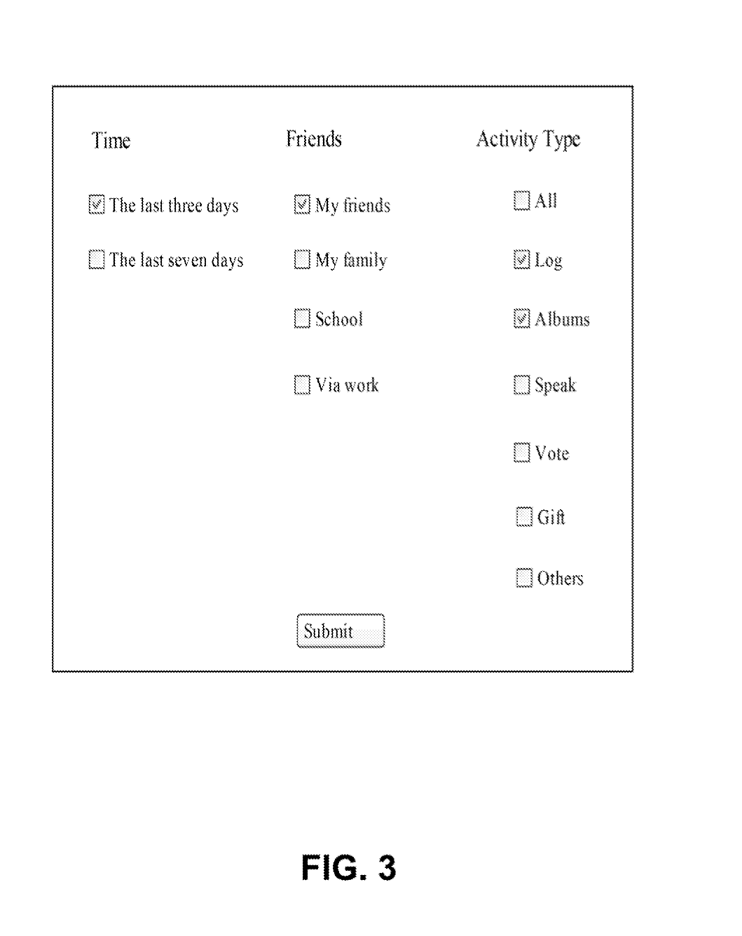

FIG. 2 shows a flowchart of a method for displaying activities of friends according to one embodiment of the present invention. The method includes following steps:
Step S201, generating activity information based on activities of friends according to the friend relationship chain. In this embodiment, after the user logs on, according to the friend relationship chain which the user belongs to, activities in SNS cyberspace triggered by all the friends and contacts in the friend relationship chain can be obtained, and the corresponding activity information is then generated. For example, the activity could be a photo in SNS cyberspace shared by a friend in the friend relationship chain.
Step S202, extracting the attribute associated with the classification rule from the activity information, according to a preset classification rule. In this embodiment, according to at least one of an information attribute, a friend attribute or users' events attribute, the attributes associated with the classification rules from the activity information is extracted. For example, if the current classification rule is based on information attribute, then all information attributes from the activity information are extracted, such as information type attribute, information generating time attribute and so on.
Step S203, Classifying the activity information according to the attributes. In this embodiment, according to the extracted attributes, the friends' activity information in the friend relationship chain is classified one by one.
Step S204, acquiring the screening condition. In this embodiment, get the screening condition entered by the user through interface diagram, as shown by FIG. 3. In the interface diagram, the screening condition acquired is derived from all the logs and albums of user's friends during the last three days.
Step S205, retrieving the classification collection corresponding to the screening condition. In this embodiment, according to the screening condition, screen the classification collection to get the activity information that totally meets the screening condition.
   In other embodiments, the screening condition comprises multiple screening conditions. After step S205, there is another step included: obtaining intersection from the screened classification collection. In this embodiment, if the screening condition has several items, the same and different activity information both exists in the screened classification collection. There is a need to get intersection from the screened classification collection, so we can get the activities meeting all the screening conditions.
Step S206, extracting the activity information from the classification collection, and displaying the activity information extracted. In this embodiment, the extracted activity information in friends' SNS cyberspace is displayed, so it is easy for the user to view the activities of friends.

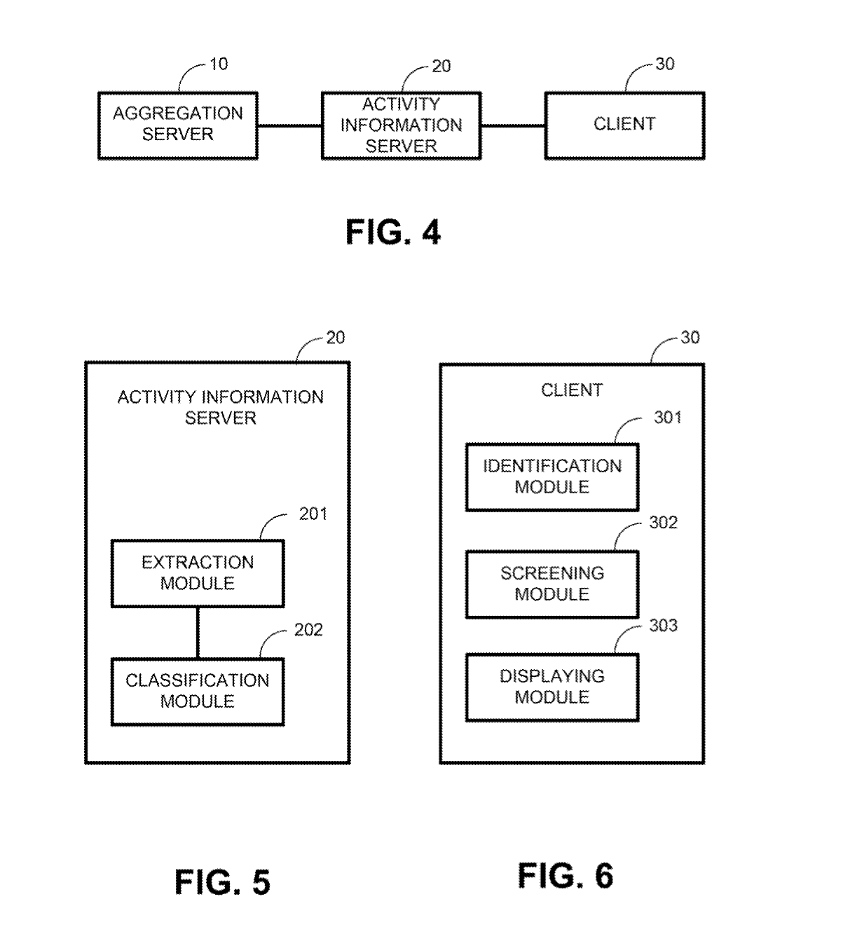

FIG. 4 shows the schematic diagram of a system displaying activities of friends. The system includes an aggregation server 10, an activity information server 20 and a client terminal 30.

The aggregation server 10 is configured to generate activity information from the activities of friends according to the friend relationship chain. In this embodiment, the aggregation server 10 generates the activity information from the activities of friends according to all the user's friends and contacts in the friend relationship chain.

The activity information server 20 is configured to classify the activity information according to a preset classification rule to obtain the corresponding classification collection. In this embodiment, as mentioned above, the classification rules that the activity information server 20 gets include one or more of an information attribute, a friend attribute or users' events attribute.

The client terminal 30 is configured to acquire the screening condition, extracting activity information that meets the screening condition from the classification collection, and displaying the activity information extracted. In this embodiment, the client terminal 30 acquires the screening condition entered by a user, according to the screening condition, extracts and displays activity information that meets the screening condition from the classification collection.

FIG. 5 shows a block diagram of an activity information server according to one embodiment of the present invention. The activity information server 20 includes an extraction module 201 and a classification module 202.

The extraction module 201 is configured to extract the attribute associated with the classification rule from the activity information, according to the preset classification rule. In this embodiment, the extraction module 201 is configured to extract the attribute associated with the classification rule from the activity information, according to at least one of an information attribute, a friend attribute or a users' events attribute.

The classification module 202 is configured to classify the activity information according to the attributes. In this embodiment, according to the extracted attributes, the classification module 202 classifies the friends' activity information in the friend relationship chain one by one.

In one embodiment, FIG. 6 shows a block diagram of a client terminal. The client terminal 30 includes an identification module 301, a screening module 302 and a displaying module 303.

The identification module 301 is configured to acquire the screening condition. In this embodiment, the identification module 301 receives a screening condition entered by the user through an interface (not shown in FIG. 6).

The screening module 302 is configured to retrieve the classification collection corresponding to the screening condition. In this embodiment, according to the screening condition, screening module 302 screens the classification collection to get the activity information that totally meets the screening condition.

In other embodiments, if the screening condition comprises multiple screening conditions, the client terminal 30 further comprises a merge module, which is configured to obtain intersection from the screened classification collection. In one embodiment, if the screening conditions contain several items, the same and different activity information both exist in the screened classification collection. There is a need to use the merge module in the client terminal 30 to get intersection from the screened classification collection. Therefore, the activities that meet all the screening conditions can be obtained.

The displaying module 303 is configured to extract the activity information from the classification collection, and display the activity information extracted.

Furthermore, the invention also provides a non-transitory computer storage medium having computer executable instructions stored thereupon, which, when executed by a computer, cause the compute to execute a method for displaying activities of friends.

The embodiment below indicates the methods, system as well as the computer storage medium for displaying activities of friends. In this embodiment, a client terminal 30 is used for user's logging on and an aggregation server 10 obtains the activities in SNS cyberspace triggered by all the friends and contacts in the friend relationship chain, and packages the activities of friends into a activities file with feed type. An extraction module 201 extracts information attribute and friend attribute from obtained activity information. An classification module 202 is configured to classify the activity information to form the classification collection, according to information type, information generating time, age, gender, user group which friends belong to. An identification module 301 of the client terminal 30 obtains the screening condition inputted by the user through interface diagram, as shown in FIG. 3. In the screening condition, information generating time is in recent three days, the user's group friends belong to is “my friend”, and information type are log and photo album. Because the screening condition have multiple items, after screening module 302 obtains the screened classification collection, the merge module gets intersection from the screened classification collection to generate the activities which is used for displaying module 303 to display to the user.

Through the method and system for displaying activities of friends, after classifying and screening the activity information, we can get and further display friends' activities which meet the screening condition inputted by the user. The invention realizes the rapid screening in large amount of information, providing all the friends' effective activities rapidly for the user, meeting users' demand for personalized browsing.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for displaying activities of friends, comprising
generating activity information from the activities of friends according to a friend relationship chain;
classifying the activity information according to a preset classification rule to obtain a corresponding classification collection; and
acquiring a screening condition to extract activity information that meets the screening condition from the classification collection, and displaying the activity information extracted.

2. The method of claim 1, wherein the classifying of the activity information according to the preset classification rule to obtain the corresponding classification collection comprises:
extracting an attribute associated with the classification rule from the activity information, according to the preset classification rule; and
classifying the activity information according to the attributes to form the classification collection.

3. The method of claim 2, wherein the classification rule comprises at least one of an information attribute, a friend attribute, and a user event attribute.

4. The method of claim 1, wherein the acquiring of the screening condition, extracting activity information that meets the screening condition from the classification collection, and displaying the activity information extracted comprises:
acquiring the screening condition;
obtaining the classification collection corresponding to the screening condition; and
extracting the activity information from classification collection corresponding to the screening condition, and displaying the activity information extracted.

5. The method of claim 4, wherein the screening condition comprises multiple screening conditions.

6. The method of claim 5, further comprising:
obtaining intersection from the classification collection corresponding to the screening condition.

7. A system for displaying activities of friends, comprising:
an aggregation server configured to generate activity information from the activities of friends according to a friend relationship chain;
an activity information server configured to classify the activity information according to a preset classification rule to obtain a corresponding classification collection; and
a client terminal configured to acquire a screening condition, extracting activity information that meets the screening condition from the classification collection, and displaying the activity information extracted.

8. The system of claim 7, wherein the activity information server comprises:
an extraction module configured to extract an attribute associated with the classification rule from the activity information, according to the preset classification rule; and
a classification module configured to classify the activity information according to the attribute to form the classification collection.

9. The system of claim 8, wherein the classification rule comprises at least one of an information attribute, a friend attribute, and a user event attribute.

10. The system of claim 7, wherein the client terminal comprises:
an identification module configured to acquire the screening condition;
a screening module configured to obtain classification collection corresponding to the screening condition; and
a displaying module configured to extract the activity information from the classification collection corresponding to the screening condition, and display the activity information extracted.

11. The system of claim 10, wherein the screening condition comprises multiple screening conditions.

12. The system of claim 11, wherein the client terminal further comprises:
a merge module configured to obtain intersection from the classification collection corresponding to the screening condition.

13. A non-transitory computer storage medium having computer-executable instructions stored thereupon which, when executed by a computer, cause the computer to execute a method for displaying activities of friends, the method comprising:
generating activity information from the activities of friends according to a friend relationship chain;
classifying the activity information according to a preset classification rule to obtain the corresponding classification collection;
acquiring a screening condition, extracting activity information that meets the screening condition from the classification collection, and displaying the activity information extracted.

14. The non-transitory computer storage medium of claim 13, wherein the classifying of the activity information according to the preset classification rule to obtain the corresponding classification collection comprises:
extracting an attribute associated with the classification rule from the activity information, according to the preset classification rule; and
classifying the activity information according to the attribute to form the classification collection.

15. The non-transitory computer storage medium of claim 14, wherein the classification rule comprises at least one of an information attribute, a friend attribute, and a user event attribute.

14. The non-transitory computer storage medium of claim 13, wherein the acquiring of the screening condition, extracting activity information that meets the screening condition from the classification collection, and displaying the activity information extracted comprises:
acquiring the screening condition;
obtaining classification collection corresponding to the screening condition; and
extracting the activity information from the classification collection corresponding to the screening condition, and displaying the activity information extracted.

15. The non-transitory computer storage medium of claim 14, wherein the screening condition comprises multiple screening conditions.

16. The non-transitory computer storage medium of claim 15, wherein the method further comprises:
obtaining intersection from the classification collection corresponding to the screening condition.
